(19) United States
(12) Patent Application Publication
(10) Pub. No.: US 2026/0301426 A1
(43) Pub. Date: Oct. 1, 2026

(54) DRIVING ASSISTANCE DEVICE AND STORAGE MEDIUM

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventor: Kanta ONODA, Tokyo (JP)

(21) Appl. No.: 19/570,559

(22) Filed: Mar. 18, 2026

(30) Foreign Application Priority Data
Mar. 25, 2025 (JP) 2025-050564

(51) Int. Cl. G06V 20/58; G06V 10/74

(52) U.S. Cl. CPC G06V 20/582; G06V 10/74

(57) ABSTRACT

A driving assistance device is configured to recognize road signs based on an image captured by a camera mounted to an own vehicle and to perform driving assistance for the own vehicle based on the recognition result. The driving assistance device includes: a first control unit configured to invalidate the recognition result of a road sign and configured not to perform the driving assistance based on the recognition result in a case that the road sign is recognized based on the image captured during the first period from when a start condition of turning is satisfied to when a termination condition of turning is satisfied while the own vehicle is at an intersection, and a second control unit configured not to perform the driving assistance in a case that a road sign is recognized based on the captured image during a second period following the first period, and that road sign is the same road sign that was invalidated during the first period.

### CROSS-REFERENCE TO RELATED APPLICATIONS

The present application claims priority to Japanese Application No. 2025-50564, filed on Mar. 25, 2025. The contents of this application are incorporated herein by reference in their entirety.

### BACKGROUND

### 1. Technical Field

This disclosure relates to a driving assistance device and a storage medium.

### 2. Related Art

Conventionally, as a driving assistance process for a vehicle, a technique is known for recognizing road signs based on images captured by an in-vehicle camera of an area ahead of the vehicle and displaying information of the recognized road sign in a position where the vehicle occupants can visually perceive it. A driving assistance device described in JP2019066963A (hereinafter referred to as Patent Document 1), when a vehicle turns at an a intersection, does not notify the driver of information of a road sign recognized on the straight road before turning during a predetermined period while turning, and avoids erroneously displaying the recognition result of the road sign recognized before turning after the vehicle has completed the turn.

### SUMMARY

The driving assistance device of the present disclosure is a driving assistance device configured to recognize road signs based on an image captured by a camera mounted to an own vehicle and to perform driving assistance for the own vehicle based on the recognition result. The driving assistance device comprises: a first control unit configured to invalidate the recognition result of a road sign and configured not to perform the driving assistance based on the recognition result in a case that the road sign is recognized based on the image captured during the first period from when a start condition of turning is satisfied to when a termination condition of turning is satisfied while the own vehicle is at an intersection, and a second control unit configured not to perform the driving assistance in a case that a road sign is recognized based on the captured image during a second period following the first period, and that road sign is the same road sign that was invalidated during the first period.

### BRIEF DESCRIPTION OF THE DRAWINGS

FIG. 1 is a schematic diagram illustrating an overview of a vehicle driving assistance system.

FIG. 2 is a diagram illustrating a road sign display processing of a prior art.

FIG. 3 is a diagram illustrating a road sign display processing of an embodiment.

FIG. 4 is a flowchart showing the processing steps for road sign display processing.

### DETAILED DESCRIPTION OF THE PREFERRED EMBODIMENTS

In the driving assistance device described in Patent Document 1, once a predetermined period terminates, a new road sign is searched for displaying information of a road sign corresponding to the next road to be traveled (the road after turning right or left). However, when the vehicle is in the process of turning, a road sign located on a road farther away than the intersection (e.g., on the road beyond the intersection when proceeding straight through it) may be captured in the camera image. Therefore, there is a concern that a road sign that is unnecessary for traveling on the road after turning right or left may be displayed.

Driving assistance processing includes not only displaying images on the display based on road sign recognition results but also controlling driving states of the vehicle based on the road sign recognition results. In this case too, when driving assistance processing is performed based on the road sign recognition results which are unnecessary when driving on the road after turning right or left, there is concern that the driving assistance processing may not be executed properly.

This disclosure is made in light of the above problems and aims to provide a driving assistance device and a storage medium capable of properly performing driving assistance process while a vehicle is turning right or left.

The driving assistance device of the present disclosure is a driving assistance device configured to recognize road signs based on an image captured by a camera mounted to an own vehicle and to perform driving assistance for the own vehicle based on the recognition result. The driving assistance device comprises: a first control unit configured to invalidate the recognition result of a road sign and configured not to perform the driving assistance based on the recognition result in a case that the road sign is recognized based on the image captured during the first period from when a start condition of turning is satisfied to when a termination condition of turning is satisfied while the own vehicle is at an intersection, and a second control unit configured not to perform the driving assistance in a case that a road sign is recognized based on the captured image during a second period following the first period, and that road sign is the same road sign that was invalidated during the first period.

At an intersection where the vehicle is in state of turning right or left, the road sign of the road on the far side which the vehicle will not travel on after passing through the intersection, may be recognized. Regarding this point, the driving assistance device invalidates the recognition result of such road sign even if it is recognized based on the image captured during the first period from when start condition of turning is satisfied until the termination condition of turning is satisfied and does not perform driving assistance based on that road sign (first control unit). This suppresses unnecessary driving assistance based on road signs corresponding to roads the vehicle does not travel on. In the second period following the first period, both a road sign for a road the vehicle travels on after passing through the intersection and a road sign for a road the vehicle does not travel on may be recognized. Regarding this point, the driving assistance device does not perform the driving assistance even if a road sign is recognized based on the image captured during the second period in a case that the road sign is the same road sign that was invalidated during the first period (second control unit). This enables proper driving assistance while correctly determining whether a road sign should be used for the driving assistance when the vehicle turns right or left onto a different road.

The following describes an embodiment of a driving assistance device of the present disclosure, with reference to drawings. In this embodiment, the driving assistance device is included in a driving assistance system that provides driving assistance for vehicles such as passenger cars, trucks, and buses.

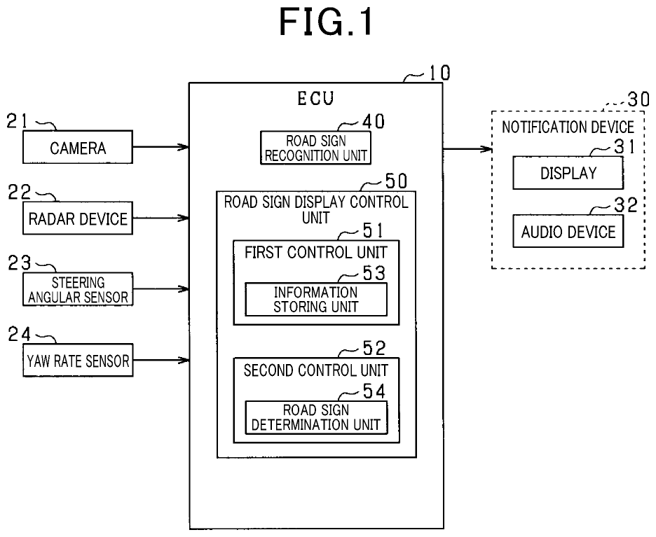

As shown in FIG. 1, the driving assistance system according to this embodiment is provided with an ECU 10 (Electronic Control Unit), a camera 21, a radar device 22, a steering angular sensor 23, a yaw rate sensor 24, and a notification device 30. The ECU 10 is an example of the driving assistance device. The notification device 30 includes a display 31 for displaying various information to be notified to a driver and an audio device 32 for outputting various information to be notified to the driver via voice. The display 31 is positioned within a vehicle cabin where it is visible to the driver.

The camera 21 is an in-vehicle camera, such as a CCD camera. For example, the camera 21 may be mounted near the upper portion of the front windshield within the vehicle cabin and captures a region in a predetermined imaging range in front of the vehicle. The camera 21 continuously captures images at a predetermined time interval (predetermined cycle) and transmits the captured images to the ECU 10. The camera 21 may be a monocular camera or a stereo camera.

The radar device 22 may be a ranging device that transmits millimeter-wave band high-frequency signals as probe waves. The radar device 22 may be mounted, for example, at a front end and a rear end of the vehicle (hereinafter, referred to as own vehicle) and may measure distance to an object around the own vehicle. Specifically, the radar device 22 transmits probe waves at a predetermined cycle, receives reflected waves via multiple antennas, and measures the distance to the object based on the transmission time of the probe wave and the reception time of the reflected wave. The radar device 22 calculates azimuth of the object based on the phase difference of the reflected waves received by the multiple antennas respectively. By calculating both the distance to the object and its azimuth, the relative position of the object with respect to the own vehicle is determined.

The steering angular sensor 23 is a sensor that detects steering angle of a steering wheel of the own vehicle (an angle corresponding to a turning angle of the own vehicle). The yaw rate sensor 24 detects a yaw rate generated when the own vehicle turns.

The ECU 10 is an electronic control unit comprising a microcomputer including a processor (CPU), ROM, RAM, flash memory, etc. The microcomputer provides various computational functions. The functions provided by the microcomputer are realized by software stored in a tangible storage medium and a computer executing it, by software alone, by hardware alone, or by a combination thereof. The microcomputer executes programs stored in a non-transitory tangible storage medium, which is its own memory. The programs include, for example, object recognition processing to recognize objects around the own vehicle and processing to avoid collisions with objects around the own vehicle or mitigate damage in the event of a collision. Execution of the program causes the corresponding method to be performed. The memory is, for example, a non-volatile memory. The program stored in the memory may be updated, for example, via a network such as the Internet.

The ECU 10 acquires object detection information from each of the camera 21 and the radar device 22 and recognizes objects around the own vehicle based on the object detection information. For example, the ECU 10 recognizes objects by fusing (combining) image information, which includes the distance to the object and the azimuth of the object calculated based on the camera image, with radar information, which includes the distance to the object and the azimuth of the object obtained from the radar device 22.

In this embodiment, the ECU 10 recognizes road signs installed on the road based on the image captured by the camera 21 and performs driving assistance processing for the own vehicle based on the recognition results. More specifically, the ECU 10 recognizes at least one of presence, position, and type of road signs (road sign information) based on the camera image and causes the display 31 to display information of the recognized road sign. This notifies the driver of the own vehicle of regulatory information, cautionary information, etc., on the road where the own vehicle is traveling. The road sign recognized by the ECU 10 may include speed limit signs, one-way signs, no entry signs, directional signs, etc. The following details the road sign display processing performed based on the road sign recognition results.

First, a prior art of a road sign display processing during left turns at an intersection is described. In a device according to the prior art (hereinafter, referred to as a prior art device), the period from when the turn signal is activated on the vehicle CA # until the turning angle θ of the vehicle reaches or exceeds a predetermined angle θA is defined as first period TA. During the first period TA, the road sign recognized from the image captured by camera 21 is not displayed on display 31. The turning angle θ is defined as zero when the vehicle is traveling straight and is represented by a positive value regardless of whether the turn is to the right or left. After the end of the first period TA, when a road sign is recognized on the road the vehicle will travel on after turning right or left, information of the road sign is displayed on display 31. Intersections do not necessarily involve roads intersecting at right angles (90 degrees); some intersect at obtuse angles allowing turns with angles smaller than 90 degrees. Therefore, to accommodate diverse intersections, the predetermined angle θA (angle threshold) set as the termination condition for the first period TA is set to an angle smaller than 90 degrees, such as 45 degrees.

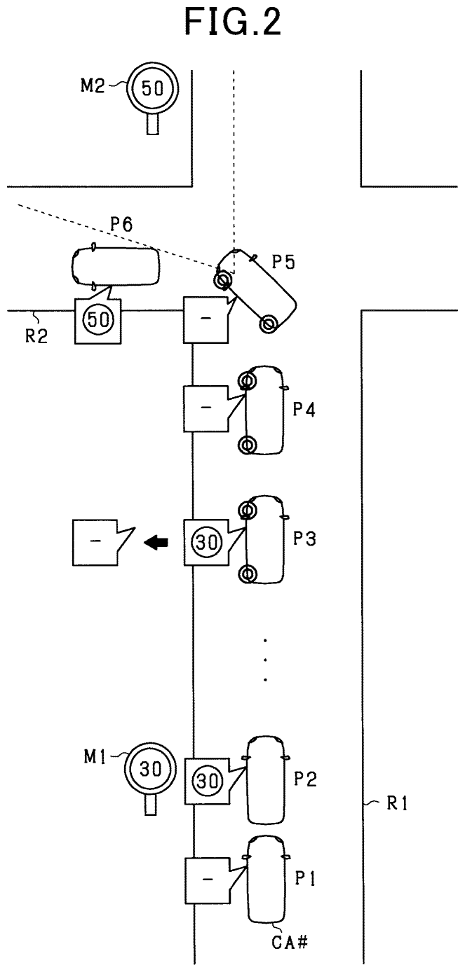

FIG. 2 is a diagram illustrating a conventional road sign display processing. FIG. 2 shows an intersection where a first straight road R1 and a second straight road R2 intersect. On roadside of the first straight road R1, an road sign M1 showing a speed limit of 30 km/h is installed closer to the vehicle than to the intersection, while a road sign M2 showing a speed limit of 50 km/h is installed farther than the intersection. The vehicle CA turns left at the cross intersection.

In FIG. 2, the vehicle CA # passes through positions P1, P2, P3, P4, P5, and P6 in sequence. When passing the position P1, the road sign M1 is recognized. When passing the position P2, which is lateral to the road sign M1, an image indicating the current speed limit of 30 km/h is displayed on display 31.

Subsequently, the vehicle CA # indicates its intention to turn left at the intersection by activating the turn signal at position P3, which is closer to the intersection than to the position P2. The vehicle CA # then turns left within the intersection while the turn signal remains activated. The vehicle CA # determines that it has entered the first period TA upon turning on the turn signal at position P3. In preparation for turning left, an image showing an information of the speed display road sign M1 shown on display 31 is cleared.

Subsequently, at the position P5, the turning angle θ of the vehicle CA # becomes greater than or equal to the predetermined angle θA and it is determined that the first period TA has terminated. In the illustrated scene, when the vehicle CA # is at the position P5, the road sign M2, located farther from the intersection of the first straight road R1, is recognized via the camera image. Therefore, when the vehicle CA # advances to the position P6, as the vehicle CA #passes alongside the road sign M2, the display 31 may erroneously display that the current speed limit is 50 km/h (the information from the road sign M2). In the above scenario, although the first straight road R1 farther from the intersection is a road the vehicle CA # does not travel on, there is concern that the road sign M2, located on the first straight road R1 beyond the intersection, may be erroneously displayed on display 31 by conventional devices.

On the other hand, in this embodiment, as a countermeasure against the erroneous displaying of a road sign, when a road sign is recognized based on the captured image during the second period TB following the first period TA, displaying information of the road sign on the display 31 is prohibited.

The driving assistance control based on the road sign recognition according to the embodiment is described in detail below. In FIG. 1, the ECU 10 includes a road sign recognition unit 40 and a road sign display control unit 50.

The road sign recognition unit 40 recognizes road signs which exist ahead of the own vehicle CA based on images captured by the camera 21. For example, the road sign recognition unit 40 may store multiple image patterns representing various road signs respectively in the memory beforehand. The road sign recognition unit 40 may then perform pattern matching using these multiple patterns on images captured by the camera 21 for recognizing road signs in an area ahead of the own vehicle. For instance, image patterns corresponding to each speed limit may be stored in the memory for recognizing.

The road sign display control unit 50 causes the display 31 to display an image representing the road sign, recognized by the road sign recognition unit 40. The road sign includes at least one road sign in which corresponding image is displayed by the display 31 immediately upon recognition by the road sign recognition unit 40, and at least another road sign in which corresponding image is not displayed by the display 31 immediately upon recognition by the road sign recognition unit 40 and the corresponding image is displayed by the display 31 when the own vehicle CA passes alongside it. For example, a speed limit sign is not displayed on the display 31 at the time of recognition but is displayed on the display 31 when the own vehicle CA reaches the road sign.

The road sign display control unit 50 comprises a first control unit 51 and a second control unit 52. Each of the first control unit 51 and the second control unit 52 performs control related to the display of road sign when the own vehicle CA passes through the intersection.

When the own vehicle CA turn right or left at and intersection, in a case that a road sign is recognized by the road sign recognition unit 40 based on a captured image during the first period TA invalidates the road sign recognition result and does not cause the display 31 to display road sign information. The first period TA starts when the start condition of turning is satisfied and terminates when the termination condition of turning is satisfied. In this embodiment, the start condition of turning is that the turn signal is activated indicating the own vehicle CA starts turning and the termination condition of turning is that the turning angle θ of the own vehicle CA is equal to or greater than a predetermined angle θA.

The turning angle θ of the own vehicle CA may be calculated based on the detection result of the steering angular sensor 23. Alternatively, the turning angle θ of the own vehicle CA may be calculated based on the detection result of the yaw rate sensor 24. The predetermined angle θA, which is an angle threshold, is set to an angle smaller than 90 degrees, and may be, for example, 45 degrees. The predetermined angle θA may be set to any angle smaller than 90 degrees, such as 30 degrees, 60 degrees, etc.

The first control unit 51 may include an information storing unit 53 that stores road sign information, including type and position, for road signs recognized by the road sign recognition unit 40 based on the captured image during the first period TA and subsequently invalidated. The type in the road sign information may include, for example, being a speed limit sign and its speed limit information. The position of the road sign may include, for example, information indicating the specific location where the road sign was installed on roads intersecting each other at an intersection. The position information of the road sign may be coordinates on a map. Each road sign information for each road sign may be assigned an identification number (ID). The information stored by the information storing unit 53 is the historical information of the road sign recognized by the road sign recognition unit 40 during the first period TA and invalidated by the first control unit 51.

The second control unit 52 does not cause the display 31 to display the road sign information, in a case that during second period TB following the first period TA, a road sign is recognized by the road sign recognition unit 40 based on the captured image and the recognized road sign is the same road sign that was invalidated during the first period TA. For example, the second period TB may be period from the end timing of the first period TA until the own vehicle CA travels a predetermined distance on the road entered after turning right or left. The predetermined distance may be, for example, 50 m, 60 m, 70 m, etc. However, the second period TB may also be the period until a predetermined time elapses from the end timing of the first period TA. In this case, the second period TB is the period starting from the end of the first period TA until the own vehicle CA travels for a predetermined time (e.g., approximately 10 seconds) on the road entered after turning right or left.

The second control unit 52 may include a third control unit 54 that determines whether road sign information containing the type and position of a road sign recognized by the road sign recognition unit 40 based on an image captured during the second period TB matches the road sign information stored by the information storing unit 53. The second control unit 52, in a case that the road sign determination unit 54 determines that the road sign information of the road sign recognized during the second period TB matches the road sign information stored by the information storing unit 53, does not cause the display 31 to display the road sign information corresponding to the road sign recognized during the second period TB.

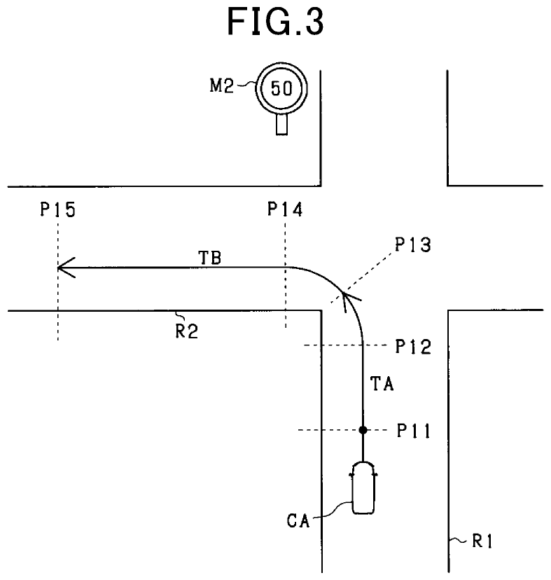

FIG. 3 is a diagram illustrating the road sign display processing according to this embodiment. FIG. 3 schematically shows roads forming an intersection. The scene shown in FIG. 3, where the own vehicle CA turns left at the intersection, is the same as in FIG. 2. FIG. 3 shows a first straight road R1 and a second straight road R2 intersecting each other, like FIG. 2. A road sign M2 showing a speed limit of 50 km/h is installed on the roadside at the far side of the intersection along the first straight road R1. FIG. 3 shows the left turn scene of the own vehicle CA, however the same processing as described below is performed for the right turn scene.

FIG. 3 shows the positions P11, P12, P13, P14, and P15 that the own vehicle CA passes through in sequence.

At the position P11, the own vehicle CA activates its turn signal.

At the position P12, the own vehicle CA starts turning left.

At the position P13, the turning angle θ of the own vehicle CA reaches or exceeds a predetermined angle θA (e.g., 45 degrees).

At the position P14, the own vehicle CA passes alongside the road sign M2 after completing the left turn.

At the position P15, the own vehicle CA has traveled a predetermined distance (e.g., 70 m) after turning left.

In this scene, the period from position P11 to P13 is an example of the first period TA, and the period from position P13 to P15 is an example of the second period TB. Note that in FIG. 3, as in FIG. 2, the road sign M1 may be recognized before the own vehicle reaches the position P11, but this is omitted from the explanation here.

During the first period TA, the road sign M2 is recognized based on camera images capturing ahead of the own vehicle CA. However, the recognition result for that road sign is invalidated and the corresponding road sign information is not displayed on the display 31. This suppresses unnecessary displays of road signs related to roads the own vehicle CA does not travel.

During the second period TB, like the first period TA, the road sign M2 is recognized based on camera images capturing ahead of the own vehicle CA. However, since the road sign M2 is the same road sign recognized during the first period TA, it is invalidated and not displayed by the display 31. This suppresses unnecessary road sign displays when the own vehicle CA turns right or left and travels on a different road.

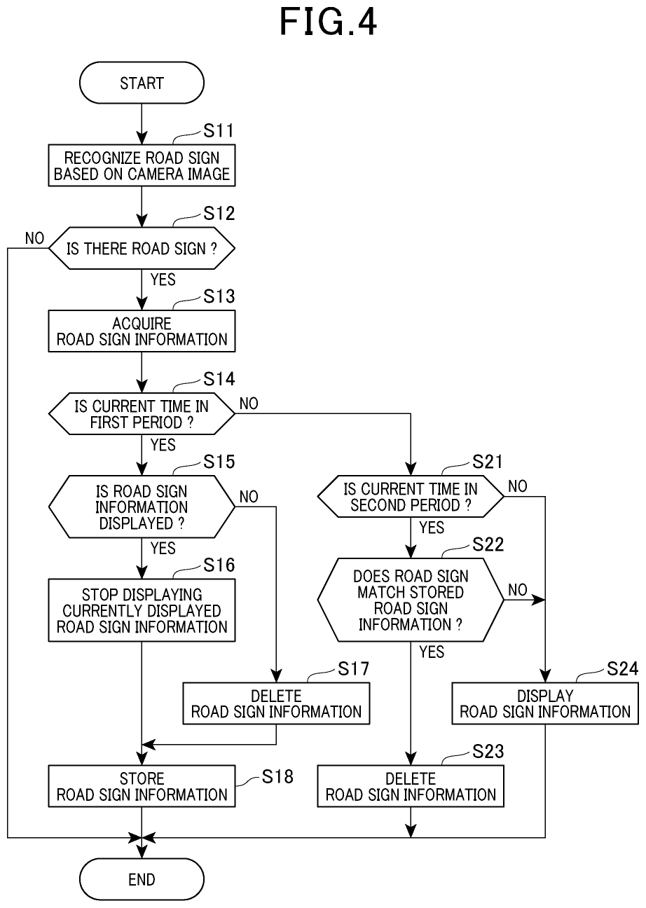

FIG. 4 is a flowchart showing the processing steps for sign display control. This process is repeatedly performed at predetermined intervals by the ECU 10. Here, an example where a speed limit sign is recognized as the road sign is described.

In step S11, the ECU 10 acquires images captured by the camera 21 and performs recognition processing to recognize road signs existing a head of the own vehicle based on the images. In step S12, the ECU 10 determines whether the presence of a road sign was recognized in step S11. In a case that the presence of a road sign was recognized, the ECU 10 proceeds to step S13. In step S13, the ECU 10 acquires road sign information for the recognized road sign. The road sign information includes the type and the position of the road sign.

In step S14, the ECU 10 determines whether the present time is within the first period TA. In a case that the ECU 10 determined that the present time is within the first period TA, the ECU 10 proceeds to step S15. In step S15, the ECU 10 determines whether the information of the road sign recognized in step S11 is displayed by the display 31. In a case that the road sign is being displayed, the ECU 10 proceeds to step S16. In a case that the road sign is not being displayed, the ECU 10 proceeds to step S17.

In step S16, the ECU 10 deletes the road sign information currently displayed by the display 31. As a result, the road sign image displayed by display 31 is erased. In step S17, the ECU 10 deletes the road sign information that was displayed by the display 31. In steps S16 and S17, the ECU 10 invalidates the road sign information corresponding to the road sign recognized based on the captured image during the first period TA and excludes it from the display targets on the display 31.

Subsequently, in step S18, the ECU 10 stores the road sign information invalidated in steps S16 and S17 in the memory.

In a case that the ECU 10 determined that the current time is not within the first period TA in step S14, the ECU 10 proceeds to step S21 and determines whether the current time is within the second period TB. In a case that the ECU 10 determined that current time is within the second period TB, the ECU 10 proceeds to step S22. In step S22, the ECU 10 determines whether the road sign recognized in step S11 (the road sign recognized during the second period TB) matches the road sign information stored in the memory in step S18 during the first period TA. For example, the ECU 10 determines whether the road sign information, which includes the road sign type and position, matches with the road sign information stored in the memory.

In a case that positive determination is made in step S22, the ECU 10 proceeds to step S23 and deletes the road sign information corresponding to the road sign recognized in step S11. In step S23, the ECU 10 invalidates the road sign information corresponding to the road sign recognized by the captured image during the first period TA and excludes it from the display targets of display 31.

In a case that negative determination is made in step S22, the ECU 10 proceeds to step S24 and causes the display 31 to display the road sign information corresponding to the road sign recognized in step S11.That is, when the road sign recognized during the second period TB does not match the road sign information recognized during the first period TA, the ECU 10 determines that the road sign recognized during the second period TB is highly likely to be valid for the road after turning right or left. Therefore, the ECU 10 causes the display to display the road sign information corresponding to the road sign recognized during the second period TB as the display target.

Furthermore, in scenarios where the own vehicle CA proceeds straight through an intersection without activating the turn signal, or where the own vehicle CA is traveling on a straight road without an intersection, negative determination is made in steps S14 and S21. In this case, the road sign information corresponding to the road sign recognized in step S11 is displayed by display 31.

According to the present embodiment described in detail above, the following excellent effects are obtained.

At an intersection where the own vehicle turns right or left, the road sign of the road on the far side which the own vehicle will not travel past after passing through the intersection may be recognized. Regarding this point, the driving assistance device invalidates the recognition result of such a road sign even if it is recognized based on the captured image during the first period and does not provide driving assistance based on that road sign. This suppresses unnecessary driving assistance based on the road sign on roads in which the own vehicle does not travel alongside. During the second period following the first period, road signs for both the road in which the own vehicle travels and the road the own vehicle does not travel may be recognized after passing through the intersection. Regarding this point, driving assistance device does not perform driving assistance in a case that the road sign is recognized based on the captured image during the second period and the road sign is the same road sign that was invalidated during the first period. This enables proper driving assistance while correctly determining whether the road sign should be used for driving assistance when the own vehicle turns right or left onto a different road.

More specifically, this embodiment stores the road sign information of the road sign recognized and invalidated during the first period TA in memory. In a case that the road sign information of the road sign recognized during the second period TB matches the road sign information of the road sign stored during the first period TA, the road sign recognized during the second period TB is not displayed. This enables proper determination of whether the road sign recognized based on the captured image during the second period TB should be used for driving assistance, thereby achieving proper road sign display.

In this embodiment, the first period TA is set to a period from when the turn signal of the own vehicle CA is activated until the turning angle of the own vehicle CA reaches or exceed the predetermined angle θA, which is less than 90 degrees. At intersections, intersecting roads do not always meet at a 90-degree angle; some intersect at obtuse angles allowing turns with angles smaller than 90 degrees. Setting termination condition of turning to a turning angle smaller than 90 degrees enables proper turn determination at diverse intersections. However, setting termination condition of turning to a turning angle smaller than 90 degrees increases the possibility of unnecessary road sign recognition during the second period TB. In this regard, as described above, the prohibition condition for road sign display during the second period TB effectively suppresses the execution of unnecessary displays caused by the road sign recognized during the second period TB.

This embodiment defines the period from the end of the first period TA until the own vehicle CA travels a predetermined distance or time on the road entered after turning as the second period TB. This enables proper road sign display on the road entered after turning.

### Other Embodiments

The above embodiment may be modified, for example, as follows.

In the above embodiment, start condition of turning was defined as the occurrence of a turn initiation indication (turn signal activation) in the own vehicle CA, but this may be modified. For example, it may be defined as start condition of turning when the turning initiation behavior occurs as the own vehicle CA enters an intersection. For example, it may be defined as that the turning initiation behavior occurs when the position of the own vehicle CA is immediately before the intersection and the turning angle of the own vehicle CA′ angle reaches or exceeds a predetermined angle (e.g., 5 degrees).

The road sign information displayed by the display 31 may be information other than that of a speed limit sign, such as information for a one-way sign, a no entry sign, a directional sign, etc.

In the above embodiment, the driving assistance processing was described as displaying road sign information by the display 31. However, this configuration may be modified to announce road sign information audibly via the audio device 32. Furthermore, the driving assistance processing may also control the running state of the own vehicle CA based on the road sign information. For example, it may control acceleration or deceleration of the own vehicle CA based on information from speed limit signs or automatically stop the own vehicle CA based on information from no-entry signs.

The control device and method described in this disclosure may be implemented by a dedicated computer provided by configuring a processor and memory programmed to execute one or more functions embodied by a computer program. Alternatively, the control device and method described in this disclosure may be implemented by a dedicated computer provided by configuring a processor using one or more dedicated hardware logic circuits. Alternatively, the control device and method described herein may be implemented by one or more dedicated computers configured by a combination of a processor and memory programmed to execute one or more functions, and one or more hardware logic circuits. Furthermore, the computer program may be stored on a computer-readable, non-transitory tangible medium as instructions executable by a computer.

What is claimed is:

1. A driving assistance device configured to recognize road signs based on an image captured by a camera mounted to an own vehicle and to perform driving assistance for the own vehicle based on the recognition result, the driving assistance device comprising:
a first control unit configured to invalidate the recognition result of a road sign and configured not to perform the driving assistance based on the recognition result in a case that the road sign is recognized based on the image captured during a first period from when a start condition of turning is satisfied to when a termination condition of turning is satisfied while the own vehicle is at an intersection; and
a second control unit configured not to perform the driving assistance in a case that a road sign is recognized based on the captured image during a second period following the first period, and that the road sign is the same road sign that was invalidated during the first period.

2. The driving assistance device according to claim 1, wherein
the first control unit comprises an information storing unit configured to store road sign information including a type and a position of the road sign recognized based on the captured image during the first period and invalidated,
the second control unit comprises a road sign determination unit configured to, in a case that a road sign is recognized based on an image captured during the second period, determine whether the road sign information containing the type and position of the road sign recognized based on an image captured during the second period matches the road sign information stored by the information storing unit, and
the second control unit is configured not to, in a case that the road sign determination unit determines that the road sign information of the road sign recognized during the second period matches the road sign information stored by information storing unit, perform the driving assistance based on the road sign recognized during the second period.

3. The driving assistance device according to claim 1, wherein
the start condition is that an action indicating the own vehicle starts turning or behavior representing the own vehicle starts turning occurs,
the termination condition is that a turning angle of the own vehicle reaches or exceeds a predetermined angle, which is less than 90 degrees, and
the second period is a period from the end timing of the first period until the vehicle travels a predetermined distance or a predetermined time on the road entered after turning.

4. A non-transitory computer-readable storage medium storing a program executed by a processor of a driving assistance device, the driving assistance device being configured to recognize road signs based on an image captured by a camera mounted to an own vehicle and to perform driving assistance for the own vehicle based on the recognition result,
wherein the program is configured to cause the processor to perform:
invalidating the recognition result of a road sign and not performing the driving assistance based on the recognition result in a case that the road sign is recognized based on the image captured during the first period from when a start condition of turning is satisfied to when a termination condition of turning is satisfied while the own vehicle is at an intersection; and
not performing the driving assistance in a case that a road sign is recognized based on the captured image during a second period following the first period, and that road sign is the same road sign that was invalidated during the first period.
